(19) United States
(12) Patent Application Publication
(10) Pub. No.: US 2008/0058036 A1
(43) Pub. Date: Mar. 6, 2008

(54) Communication device with a dielectric substrate

(75) Inventor: Masayuki Nibe, Osaka-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/812,037

(22) Filed: Jun. 14, 2007

(30) Foreign Application Priority Data
Sep. 1, 2006 (JP) 2006-237962(P)

(51) Int. Cl. H04M 1/00

(52) U.S. Cl. 455/575.1

(57) ABSTRACT

An LNB converter includes a first frame made of metal and having an edge, and a second frame made of metal and having an opposite portion opposed to the edge. It also includes a dielectric substrate arranged in a space surrounded by the first frame and second frame. The dielectric substrate includes a conductor pattern formed at a surface of the dielectric substrate. The edge and the opposite portion are fixed together by a seal member. A cushion member is arranged between the edge and the opposite portion. The cushion member is arranged to prevent the seal member from entering the space surrounded by the first frame and second frame and coming into contact with the dielectric substrate.

This nonprovisional application is based on Japanese Patent Application No. 2006-237962 filed with the Japan Patent Office on Sep. 1, 2006, the entire contents of which are hereby incorporated by reference.

### BACKGROUND OF THE INVENTION

1. Field of the Invention

The present invention relates to a communication device.

2. Description of the Background Art

In some kinds of electric devices, an electric circuit is arranged on a dielectric substrate, which is arranged inside a casing. The casing has upper and lower frames that can be divided from each other, and are opposed to each other to provide a box-like form. The electric circuit may emit electromagnetic waves when it is energized. It is preferable that electromagnetic emission does not occur because it adversely affects external equipment. Also, it is preferable that the electromagnetic waves are confined within the device. For example, communication devices cause such electromagnetic emission.

FIG. 10 schematically shows a bidirectional satellite transmit/receive system which is an example of the communication device. The bidirectional satellite transmit/receive system receives signals from a bidirectional satellite 61 by an antenna device. The antenna device includes a parabolic antenna 62. The signal provided from bidirectional satellite 61 is reflected by a surface of parabolic antenna 62 to a feed horn 65.

The antenna device includes an LNB (Low Noise Block down) converter 63. LNB converter 63 performs frequency conversion and/or amplification of a weak radio wave coming from bidirectional satellite 61 while keeping a low-noise state. The amplified signal is sent through a coaxial reception cable 71 to a room unit 73.

This antenna device includes a transmitter 64. A signal provided from room unit 73 is transmitted through a coaxial transmission cable 72 to a transmitter 64. Transmitter 64 performs frequency conversion and amplification. Feed horn 65 emits the signal subjected to the frequency conversion toward parabolic antenna 62. The surface of parabolic antenna 62 reflects the signal thus emitted to bidirectional satellite 61 as indicated by an arrow 102.

In the bidirectional satellite transmit/receive system, a user can use a television set or a computer terminal connected to room unit 73, and thereby can obtain bidirectional communications service such as satellite broadcast and Internet connection service.

FIG. 11 is a circuit block diagram showing an example of an LNB converter. The LNB converter shown in FIG. 11 is of a type that emits an output signal from one terminal or port. An incoming signal that is reflected by a surface of a parabolic antenna has a frequency between 10.7 GHz and 12.75 GHz.

Antenna probes 52 and 53 arranged inside a waveguide 66 receive the incoming signal. Antenna probe 52 receives an H-polarized wave signal. Antenna probe 53 receives a V-polarized wave signal. The signals received by antenna probes 52 and 53 are amplified by a low noise amplifier 40 in a low-noise state. Low noise amplifier 40 includes HEMTs (High Electron Mobility Transistors) serving as amplifiers 41-43. A power and switch controller 49 selectively drives amplifiers 41 and 42 to select the polarized wave.

The signal amplified by low noise amplifier 40 passes through a Band-Pass Filter (BPF) 45 that can remove signals in an image frequency range. The signal is transmitted to a mixer 46.

Mixer 46 is supplied with oscillation signals from Dielectric Resonator Oscillators (DROs) 48a and 48b, respectively. Mixer 46 mixes the output signals of dielectric resonator oscillators 48a and 48b to provide a converted signal in an Intermediate Frequency (IF) range. Dielectric resonator oscillator 48a provides a signal of 9.75 GHz in a low band. Dielectric resonator oscillator 48b provides a signal of 10.6 GHz in a high band.

The signal provided from a receiver is transmitted to power and switch controller 49, and one of the low and high bands is selected. For example, when the signal is supplied from dielectric resonator oscillator 48a, the conversion is performed to provide the signal in the intermediate frequency range between 950 MHz and 1950 MHz (low band). When the signal is supplied from dielectric resonator oscillator 48b, the conversion is performed to provide the signal in the intermediate frequency range between 1100 MHz and 2150 MHz (high band).

A polarized wave select signal and a band select signal are supplied to an output terminal 50 via a signal line from the receiver. This signal is supplied to power and switch controller 49 through a low-pass filter 51 that is formed of an inductor and a capacitor, and has a function of removing the intermediate frequency signals.

The intermediate frequency signal subjected to the frequency conversion by mixer 46 enters an intermediate frequency amplifier 47 so that it may have appropriate noise characteristics and gain characteristics. The signal amplified by intermediate frequency amplifier 47 is output from output terminal 50.

In the electric circuit shown in FIG. 11, a bypass capacitor 54 is arranged near the power supply. The bypass capacitor has a high capacitance of 1000 pF or more, and is arranged, e.g., near a terminal of an integrated circuit that may be a source of noises and/or oscillation signals.

FIG. 12 is an example of a circuit block diagram of the transmitter. An input signal of this transmitter is an intermediate frequency signal of a frequency between 950 MHz and 1450 MHz. This input signal is supplied from an input terminal 55. The input signal is passed through a high-pass filter 81, and then is amplified by an intermediate frequency amplifier 82. A gain adjuster 90 adjusts a gain of the signal. Thereafter, the signal is amplified by an intermediate frequency amplifier 83, and then is transmitted through band-pass filter 45 to a mixer 84.

Since a dielectric resonator oscillator 89 supplies the signal of 13.05 GHz, mixer 84 converts the frequency to a value between 14.0 GHz and 14.5 GHz. The signal subjected to the frequency conversion is passed through band-pass filter 45, and is amplified by radio-frequency amplifiers 85 and 86 as well as a high-power amplifier 87. Band-pass filter 45 arranged in each position cuts off not only the image range but also a receive signal range and spurious signals.

The signal amplified by high-power amplifier 87 is output from an output terminal 56. For example, the signal is output toward the surface of the parabolic antenna, and thereby is transmitted to the bidirectional satellite.

The communication device such as the LNB converter or the transmitter is arranged outdoors as shown in FIG. 10. For minimizing an influence exerted by external circumstances to the communication device, it is preferable that the dielectric substrate and the circuits formed thereon are arranged in the casing having airtightness. Further, in the LNB converter and the transmitter, it is preferable that the casing has a shielding property against electromagnetic waves emitted from the internal circuitry.

The above kind of communication device generally employs an independent member arranged outside the casing for ensuring the airtightness. In recent years, however, such casings have been employed that have functions of holding the dielectric substrate and ensuring the airtightness and the electromagnetic shielding for reducing the number of parts.

FIG. 13 is a schematic cross section of an end portion of a casing of a communication device according to a prior art. This communication device has the casing including frames 1 and 2. The communication device includes a circuit substrate, i.e., a dielectric substrate 5. Dielectric substrate 5 is held and fixed between frames 1 and 2. Dielectric substrate 5 is provided at its surface with a conductor pattern 11 providing interconnections for power supply and signal transmission. Dielectric substrate 5 is also provided at its surface with ground patterns 12 and 13. Dielectric substrate 5 has a through hole 15. A through-hole electrode 14 is formed on an inner surface of through hole 15.

In this communication device, grounding patterns 12 and 13 formed on dielectric substrate 5 must be in contact with frames 1 and 2 for achieving the shielding effect against electromagnetic wave. For improving the shielding effect, it is preferable that frames 1 and 2 are in direct contact with each other. However, a space is formed between an edge 1a of frame 1 and a concavity 2a of frame 2 for holding dielectric substrate 5 therebetween and for reliably bringing grounding patterns 12 and 13 of dielectric substrate 5 into contact with frames 1 and 2, respectively. This space is filled with a seal member 22 for ensuring the airtightness.

Japanese Patent Laying-Open No. 2002-335094 has disclosed a printed circuit board that is provided at its entire surface, in an adhered fashion, with an electromagnetic interference shield including a dielectric coating configured to form an insulating film and having a low viscosity and a high adhesivity as well as an electrically conductive coating having a low viscosity and configured to prevent emission of electromagnetic radiations caused by the printer circuit board.

Japanese Patent Laying-Open No. 2005-019900 has disclosed an electronic device including electronic part elements that are arranged on an interconnection substrate and are coated with a first resin member having an electrically insulating property. An annular ground electrode pattern surrounding a region of arrangement of the electronic part elements is formed on an upper surface of the interconnection substrate and outside the first resin member. The first resin member is coated with a second resin member that has an electric conductivity, and is electrically connected to a ground electrode pattern.

Japanese Patent Laying-Open No. 2005-197852 has disclosed an LNB converter that includes a first divided cabinet, a chassis for holding a receiver circuit, and a receiver lid that is arranged inside the first divided cabinet for covering the receiver circuit. The chassis in this LNB converter includes a recess for accommodating an elastic ring, i.e., an O-ring, and the chassis is fixed to the receiver lid with the O-ring therebetween.

Japanese Patent Laying-Open No. 2001-345569 has disclosed an accommodating structure for a high-voltage switch controller. In this structure, electromagnetic shield rubber is arranged on a surface of a gasket that can be in contact with both a groove and an edge, and is fixed into the groove by an adhesive. In this accommodating structure, the gasket is fixed into the groove by the adhesive, and a high-elastic rubber in another portion elastically holds a state in which the electromagnetic shield rubber is in contact with the first and second casings.

Japanese Patent Laying-Open No. 2002-261579 has disclosed an elastic wave device in which a casing having an opening accommodates a piezoelectric substrate provided with an excitation electrode generating an elastic wave, and a lid sealingly closes an upper opening of the casing with an adhesive. In this elastic wave device, the casing is provided at its upper opening surface with an annular concavity, an outer convexity having an outer top surface located outside the concavity is formed lower than an inner concavity having an inner top surface located inside it, and the adhesive is interposed between the outer top surface and the lid.

FIG. 14 is a schematic section of a dielectric substrate of the prior art. Dielectric substrate 5 includes a dielectric layer 5a having a plate-like form. Dielectric layer 5a is provided at its main surface with a grounding layer 5b. Electromagnetic waves provided from a signal source 6 contain components of a resonance frequency of dielectric substrate 5 which are radiated from an end surface of dielectric substrate 5 as indicated by an arrow 104. Other components of the electromagnetic waves provided from signal source 6, i.e., components other that those of the resonance frequency of dielectric substrate 5 are reflected by the end surface of dielectric substrate 5 as indicated by an arrow 103, and remain within dielectric substrate 5.

A radiation signal radiated from the end surface of dielectric substrate 5 may return into dielectric substrate 5 after passing through various paths. The radiation signal radiated by the end surface of dielectric substrate 5 returns to electric elements such as a semiconductor element arranged on dielectric substrate 5, and this causes a problem such as noises and oscillation.

FIG. 15 is a schematic cross section of another dielectric substrate of the prior art. Dielectric substrate 5 shown in FIG. 15 has a through hole 5c formed at an end portion of dielectric layer 5a. Through hole 5c is filled with a conductive member. As indicated by arrow 103, the electromagnetic waves containing both the resonance frequency components of dielectric substrate 5 and the components other than the resonance frequency components are reflected by the portion of through hole 5c, and remain inside dielectric substrate 5. In this manner, it is possible to prevent unnecessary radiation of electromagnetic waves from the end surface of dielectric substrate 5.

In some cases, however, the through holes cannot be formed throughout the end portion of dielectric substrate 5 without difficulty. In these cases, a bypass capacitor is arranged in an appropriate position of the conductor pattern, and thereby unnecessary radiation of the electromagnetic wave can be suppressed. The bypass capacitor has a high capacitance of 1000 pF or more, and is arranged near a generation source (e.g., IC terminal) of noises and/or oscillation signals. Thereby, the bypass capacitor can serve to release the noises to the ground. When the frequency to be suppressed is specified, self-resonance of a low-capacitance capacitor can be used to cancel the noises so that the noises and oscillation can be suppressed.

Referring to FIG. 13, a communication device of the prior art generally uses silicon as seal member 22 for ensuring airtightness of the casing. This seal member has a dielectric constant of about 2.6. A dielectric substrate for a radio-frequency circuit generally uses a Teflon® substrate with a glass cloth. This glass cloth Teflon substrate has substantially the same dielectric rate as silicon of the seal member.

Seal member 22 has a flowability before it is cured. For example, uncured seal member 22 is liquid. Before seal member 22 is cured, it may flow into the casing formed of frames 1 and 2, and may adhere to dielectric substrate 5. Since seal member 22 and dielectric substrate 5 have similar dielectric constants, such a problem may occur that the self-resonance conditions of dielectric substrate 5 change to cause the oscillation of electric circuits.

Even when seal member 22 comes into contact with dielectric substrate 5, it may be possible to suppress the oscillation by arranging the bypass capacitor or changing the layout of conductor pattern 11. However, the oscillation frequency changes according to the position of contact between seal member 22 and dielectric substrate 5 as well as a quantity of seal member 22. Therefore, it is difficult to change uniquely the position for arranging the bypass capacitor and the conductor pattern. Thus, the position for arranging the bypass capacitor and the layout of the conductor pattern are to be changed depending on the state of contact between the seal member and the dielectric substrate, and therefore cannot be changed uniquely.

### SUMMARY OF THE INVENTION

An object of the invention is to provide a communication device preventing such a situation that a seal member filling a space between frames of a casing comes into contact with a dielectric substrate to cause oscillation of an electric circuit formed on the dielectric substrate.

A communication device according to the invention includes a first frame made of metal and having an edge, and a second frame made of metal and having an opposite portion opposed to the edge. It also includes a dielectric substrate arranged in a space surrounded by the first and second frames. The dielectric substrate includes an electric circuit formed at a surface of the dielectric substrate. The edge and the opposite portion are fixed together by a seal member. A cushion member is arranged between the edge and the opposite portion. The cushion member is arranged to prevent the seal member from entering the space and coming into contact with the dielectric substrate.

Preferably, in the invention, the dielectric substrate is fixed by being held between the first and second frames.

Preferably, in the invention, the cushion member is arranged only on a part of an opposed region between the edge and the opposite portion.

Preferably, in the invention, the cushion member includes a soft resin foam.

Preferably, in the invention, the cushion member has a surface coated with an electrically conductive sheet.

Preferably, in the invention, the cushion member includes a wave absorber made of a sponge material.

Preferably, in the invention, the communication device has a function of an LNB converter.

Preferably, in the invention, the communication device has a function of a transmitter.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross section of an end portion of an LNB converter of an embodiment.

FIG. 2 is a graph indicating a result of a first test of the embodiment and particularly illustrating a result obtained by arranging a cushion member between frames.

FIG. 3 is a graph indicating a result of the first test of the embodiment and particularly illustrating a result obtained without arranging a cushion member between the frames.

FIG. 4 schematically illustrates a result of the first test of the embodiment obtained by arranging the cushion member between the frames.

FIG. 5 schematically illustrates a result of the first test of the embodiment obtained without arranging the cushion member between the frames.

FIG. 6 is a graph indicating a result of a second test of the embodiment obtained by arranging a cushion member between the frames.

FIG. 7 is a graph indicating a result of the second test of the embodiment obtained without arranging a cushion member between the frames.

FIG. 8 schematically illustrates a result of the second test of the embodiment obtained by arranging a cushion member between the frames.

FIG. 9 schematically illustrates a result of the second test of the embodiment obtained without arranging a cushion member between the frames.

FIG. 10 schematic shows a bidirectional satellite transmit/receive system.

FIG. 11 is a circuit block diagram of an LNB converter.

FIG. 12 is a circuit block diagram of a transmitter.

FIG. 13 is a schematic cross section of an end portion of a communication device in the prior art.

FIG. 14 is a schematic cross section illustrating radiation of electromagnetic waves from a structure having a dielectric substrate not provided at its end with a through hole.

FIG. 15 is a schematic cross section illustrating movement of electromagnetic waves in a structure having a dielectric substrate provided at its end with a through hole.

### DESCRIPTION OF THE PREFERRED EMBODIMENTS

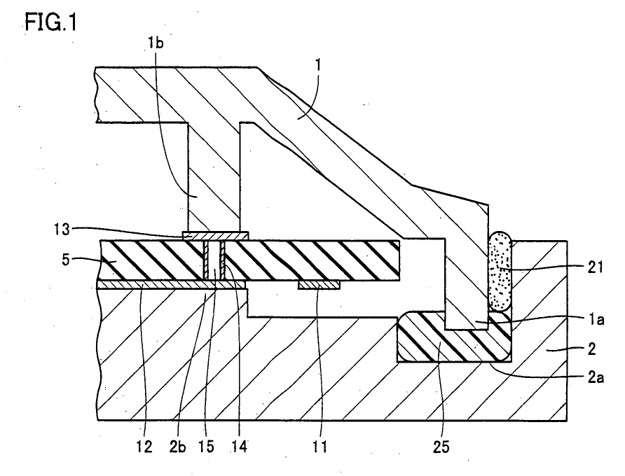

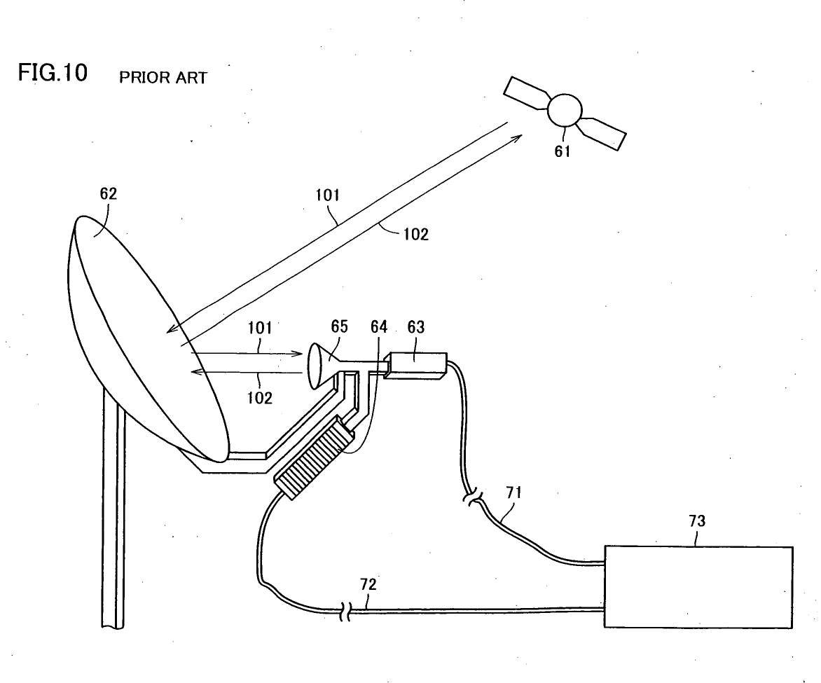

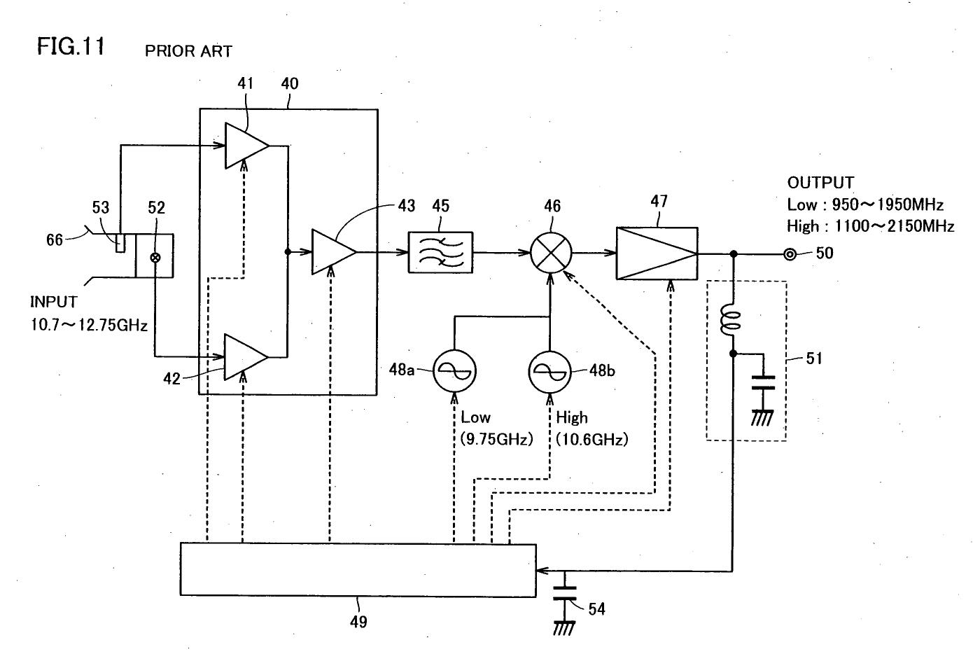

Referring to FIGS. 1 through 12, a communication device of an embodiment of the invention will now be described. The communication device of the embodiment is an LNB converter 63 employed in an antenna device (see FIGS. 10 and 11).

FIG. 1 is a schematic cross section of an end portion of the communication device of the embodiment. The communication device in this embodiment includes a casing. The casing has first frame 1 and second frame 2. The casing has a box-like shape formed of first frame 1 and second frame 2 opposed to each other. First frame 1 has an edge 1a. Second frame 2 has a concavity 2a forming an opposite portion opposed to edge 1a. The form of the opposite portion is not restricted to this, and may be a plane form.

The communication device of the embodiment includes a dielectric substrate 5 serving as a circuit board. Dielectric substrate 5 has an electric circuit formed at its surface. The electric circuit has a conductor pattern 11 serving as a power supply circuit and circuits transmitting signals. Dielectric substrate 5 is arranged in a space defined by first frame 1 and second frame 2.

Dielectric substrate 5 has grounding patterns 12 and 13 for grounding. Dielectric substrate 5 has a through hole 15. A through hole electrode 14 is formed at a side or peripheral wall of through hole 15. Through hole electrode 1-4 electrically connects grounding patterns 12 and 13 together.

Frame 1 has a contact portion 1b for contact with dielectric substrate 5. Frame 2 has a contact portion 2b for contact with dielectric substrate 5. Dielectric substrate 5 is held and fixed between contact portions 1b and 2b. Dielectric substrate 5 is arranged between first frame 1 and second frame 2.

Grounding pattern 13 is arranged on a region of the surface of dielectric substrate 5 opposed to contact portion 1b. Grounding pattern 12 is arranged on a region of the surface of dielectric substrate 5 opposed to contact portion 2b. Contact portion 1b is in contact with grounding pattern 13. Contact portion 2b is in contact with grounding pattern 12. In this embodiment, dielectric substrate 5 is held by the casing, and grounding patterns 12 and 13 are electrically connected to the casing.

Edge 1a of frame 1 is opposed to concavity 2a of frame 2. Edge 1a and concavity 2a are configured to form a space when the dielectric substrate is held between contact portions 1b and 2b. Thus, the end surface of edge 1a is spaced from concavity 2a. This structure reliably makes contact and electrical connection between the frame forming the casing and the grounding pattern.

The communication device of the embodiment has a cushion member 25. Cushion member 25 in this embodiment includes a soft resin foam, i.e., a urethane foam. The soft resin foam has elasticity. The soft resin foam includes, e.g., silicon resin or styrene resin.

Cushion member 25 has elasticity. Cushion member 25 fills a space between edge 1a and concavity 2a. Cushion member 25 is arranged between edge 1a and concavity 2a. Cushion member 25 is held and carried between edge 1a and concavity 2a.

The communication device of the embodiment has a seal member 21. Seal member 21 in this embodiment is made of silicon. Seal member 21 is arranged in the space between edge 1a and concavity 2a, and particularly in a portion outside cushion member 25. Seal member 21 adheres and fixes frames 1 and 2 together. Cushion member 25 prevents seal member 21 from protruding into the casing and coming into contact with dielectric substrate 5.

In an assembly process of the communication device in the embodiment, cushion member 25 is arranged in concavity 2a of frame 2. Then, frame 1 is arranged opposite to frame 2. Cushion member 25 is sandwiched and fixed between frames 1 and 2. Seal member 21 is arranged in the space between edge 1a of frame 1 and concavity 2a of frame 2.

Seal member 21 in this embodiment is in a liquid state until it solidifies. Since cushion member 25 is arranged between the frames, it can prevent entry of seal member 21 into the casing. The communication device in this embodiment can prevent the contact of seal member 21 with dielectric substrate 5. Consequently such a situation can be prevented that the resonance frequency of the dielectric substrate changes to cause oscillation of the electric circuit. Further, unnecessary radiation of electromagnetic waves can be suppressed.

The cushion member may have a surface covered with an electrically conductive sheet. The conductive sheet may be formed of a cloth or knit fabric of metal fibers, or may be made of resin and electrically conductive powder such as metal or carbon powder kneaded into the resin. Since the surface of the cushion member is covered with the conductive sheet, electrical continuity between the opposed frames can be attained. This can effectively suppress external leakage of the electromagnetic waves.

The cushion member may be a wave absorber made of a sponge material. The wave absorber made of the sponge material includes a soft resin foam containing an electrically conductive material. The soft resin foam containing the electrically conductive material may be prepared by foaming soft resin such as urethane that contains electrically conductive powder kneaded thereinto. The cushion member containing the wave absorber can achieve electrical continuity between the opposed frames, and can effectively suppress the external leakage of the electromagnetic waves.

The cushion member can be arranged throughout a periphery of the casing in a plane view. This structure can reliably prevent the contact of the seal member with the dielectric substrate.

The cushion member may be arranged in a part of the region where the end portion of the first frame is opposed to the opposite portion of the second frame. For example, the cushion member may be arranged in a specific region where the dielectric substrate and the seal member may neighbor and come into contact with each other. This structure can reduce a quantity of the required cushion member.

The cushion member arranged between the opposed frames preferably has elasticity. If a hard cushion member having no elasticity were arranged between the frames, the cushion member would separate the opposed frames from each other, and would separate each frame from the grounding pattern of the dielectric substrate. Consequently, the frames would not be connected to the ground, which would impair the magnetic wave shielding effect. Accordingly, it is preferable that the cushion member has appropriate elasticity so that each frame may come into contact with the grounding pattern.

The through hole in the dielectric substrate of the embodiment is provided with the metal conductor arranged on the wall surface of the hole formed in the dielectric substrate. This structure is not restrictive, and the through hole may be entirely filled with an electrically conductive material.

The dielectric substrate in the embodiment is formed of Teflon substrate with a glass cloth. However, this is not restrictive, and the dielectric substrate may be formed of an alumina ceramic substrate or a glass epoxy substrate. The dielectric substrate may have any dielectric layer.

First and second tests were performed for confirming the effect of the communication device of the embodiment. The LNB converter in the antenna device of the bidirectional satellite transmit/receive system shown in FIG. 10 was used in the tests.

The LNB converter used in the test has the foregoing electric circuit shown in FIG. 11. In the test, a return loss on an output terminal 50 of the LNB converter was measured.

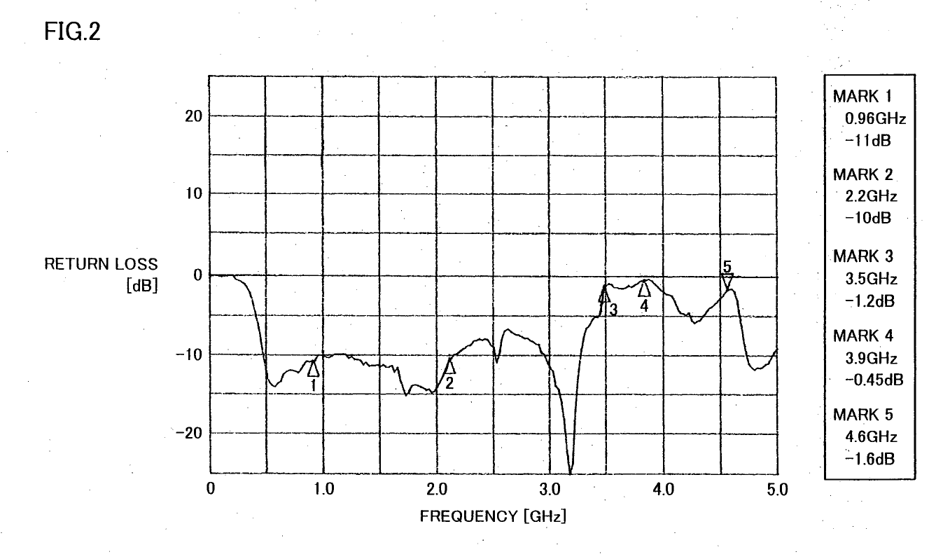

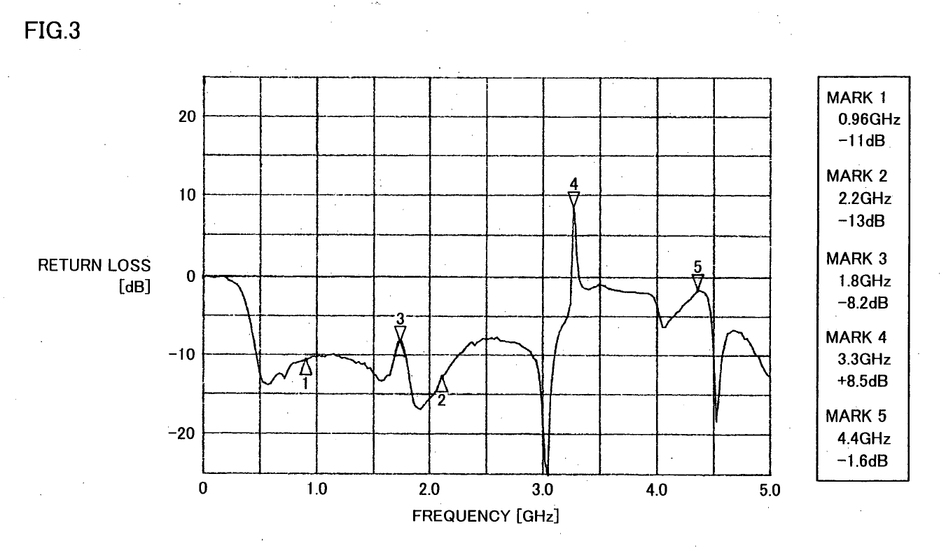

FIG. 2 is a graph relating to the first test and illustrating the return loss of the LNB converter that includes the cushion member in the embodiment. FIG. 3 is a graph relating to the first test and illustrating the return loss of the LNB converter of a comparative example that does not include the cushion member. In these graphs, the abscissa gives the frequency, and the ordinate gives the output return loss.

On the output terminal of the LNB converter, it is preferable that the return loss in the IF signal range (between 950 MHz and 2150 MHz) takes a large negative value (i.e., takes a negative value and takes a large absolute value) for achieving efficient output. It is also preferable that the return loss in the other frequency range is designed to take a small negative value (i.e., take negative value and take a small absolute value). For example, in the RF signal range (between 10.7 GHz and 12.75 GHz) and a local signal range (9.75 GHz and 10.6 GHz), such a design is preferable that the return loss takes a negative small value.

Referring to FIG. 3, in the LNB converter of the comparative example not including the cushion member, the output return loss is positive at 3.3 GHz as indicated by a mark 4. Near a mark 4, the output return loss changes to a positive, and deterioration of the return loss is seen. Although the oscillation does not occur, the resonance occurs at 1.8 GHz as indicated by a mark 3, and deterioration of the return loss is seen.

Referring to FIG. 11, the LNB converter of the comparative example includes a conductor pattern of the power supply line that connects output terminal 50 through a low-pass filter 51 to a power and switch controller 49, and this conductor pattern is arranged near the end surface of the dielectric substrate. An outer region of this conductor pattern has a portion that is not surrounded by a ground layer, e.g., a through hole. The seal member (silicon) that flowed into the casing is in contact with the dielectric substrate. It can be considered that the seal member that entered and adhered to the conductor pattern causes the resonance of the dielectric substrate at the frequency of 3.3 GHz, and backflow of this resonance to the electric circuit causes the oscillation at the frequency of 3.3 GHz.

Referring to FIG. 2, when the LNB converter is provided with the cushion member, the oscillation at 3.3 GHz and the resonance at 1.8 GHz are not seen, and the return loss takes a negative value. In this LNB converter, the conductor pattern of the power supply line that connects the output terminal to the power and switch controller is arranged near the end surface of the dielectric substrate. The urethane foam, i.e., the cushion member arranged between the frames is located in a portion where the outer side of the conductor pattern is not surrounded by the ground layer, e.g., a through hole. It can be seen that the cushion member thus arranged prevents the contact of the seal member with the dielectric substrate, and improves the return loss.

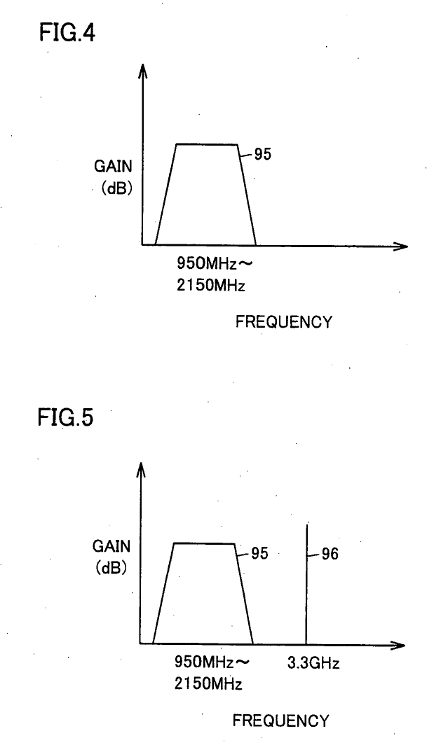

FIGS. 4 and 5 schematically illustrates the first test in this embodiment. FIG. 4 illustrates a waveform of the LNB converter of the embodiment provided with the cushion member. FIG. 5 illustrates a waveform of the LNB converter of the comparative example not provided with the cushion member. Referring to FIG. 5, it can be seen that an oscillation wave 96 at 3.3 GHz is present on a side of an IF signal wave 95 of a frequency between 950 MHz and 2150 MHz. Referring to FIG. 4, the arrangement of the cushion member can eliminate the oscillation wave at 3.3 GHz in contrast to the above.

A result of the second test in the embodiment will now be described. The second test was performed with the LNB converter similar to that in the first test. The second test differs from the first test in position where the seal member adheres to the conductor pattern arranged on the dielectric substrate.

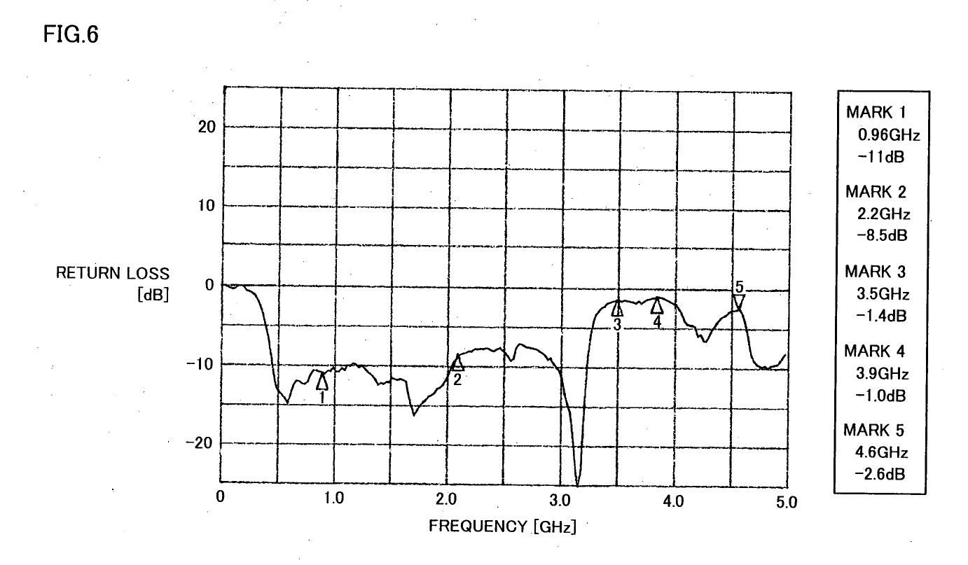

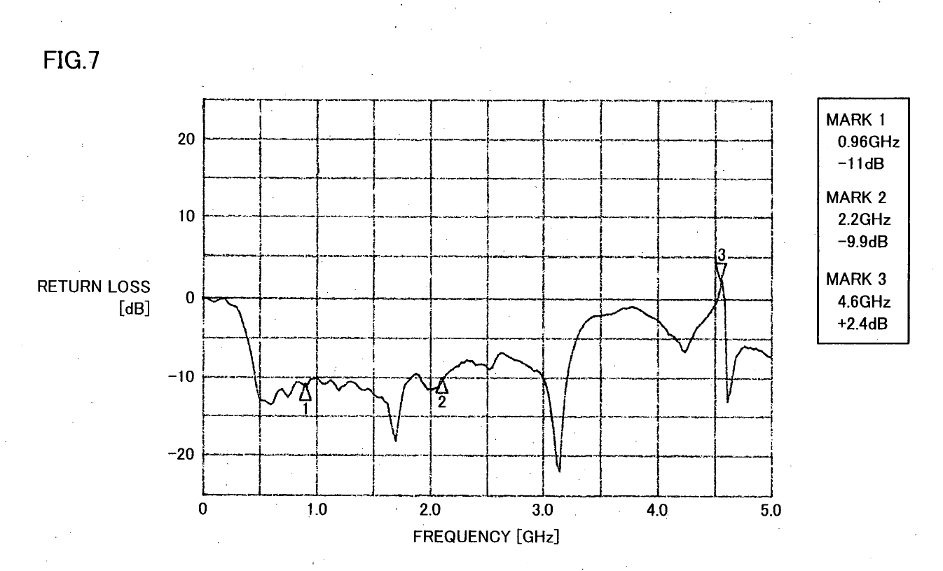

FIG. 6 is a graph of the return loss of the LNB converter of the embodiment including the cushion member. FIG. 7 is a graph illustrating the return loss of the LNB converter of the comparative example not including the cushion member.

Referring to FIG. 7, the LNB converter not including the cushion member causes oscillation at a frequency of 4.6 GHz as indicated by mark 3. In the vicinity of 4.6 GHz indicated by mark 3, the output return loss changes to a positive. In the second test, the seal member adheres to the conductor pattern of the power supply line that is the same as that in the first test, but the position of adhesion of the seal member is different from that in the first test.

Referring to FIGS. 3 and 7, it can be seen that the different positions of adhesion of the seal member cause different oscillation frequencies, respectively, even when the same device is used. It is difficult to determine the oscillation frequency for the purpose of arranging the bypass capacitor, and it is difficult to employ a manner of suppressing the oscillation by arranging the bypass capacitor. Conversely, in the embodiment, the cushion member is arranged while preventing contact of the silicon member with the dielectric substrate, and this arrangement can readily suppress the oscillation.

Referring to FIG. 6, it can be seen from the second test in the embodiment that the arrangement of the cushion member prevents the oscillation at the frequency of 4.6 GHz, and improves the return loss.

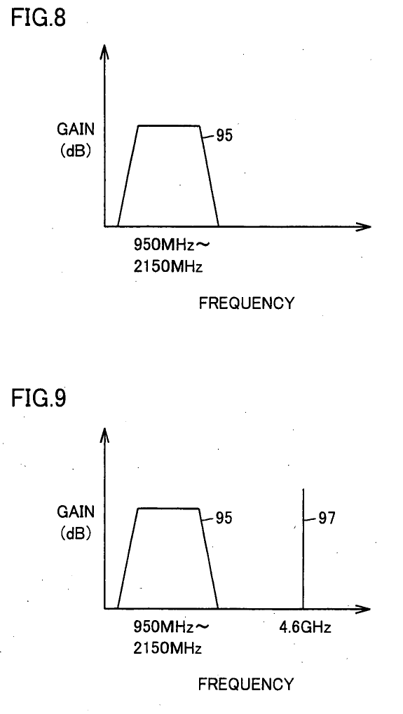

FIGS. 8 and 9 schematically illustrate the second test in the embodiment. FIG. 8 illustrates a waveform of the LNB converter including the cushion member in the embodiment. FIG. 9 illustrates a waveform of the LNB converter of the comparative example not including the cushion member. Referring to FIG. 9, it can be seen from the comparative example that an oscillation wave 97 at the frequency of 4.6 MHz is present on one side of IF signal wave 95. Referring to FIG. 8, however, the arrangement of the cushion member can eliminate the oscillation wave at the frequency of 4.6 MHz In the second test, as described above, the arrangement of the cushion member can likewise and effectively prevent the oscillation.

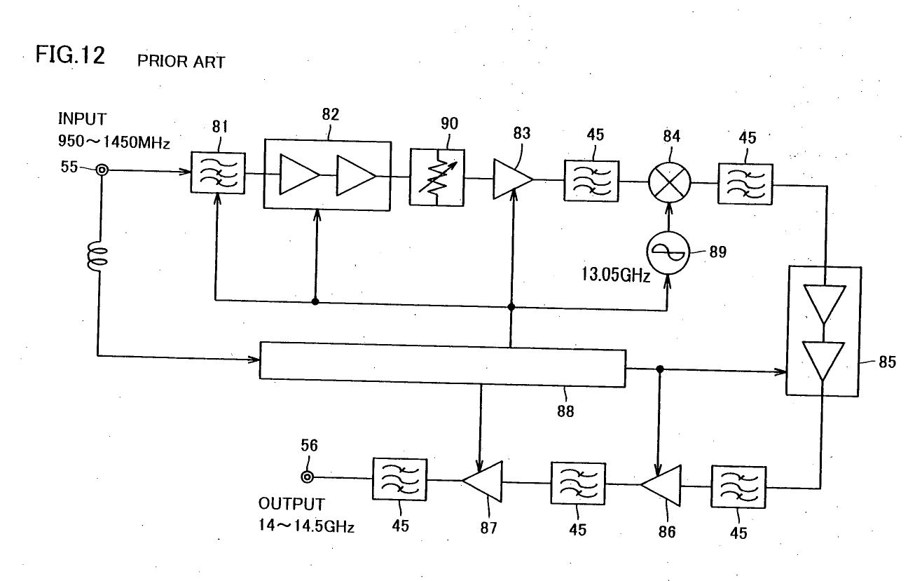

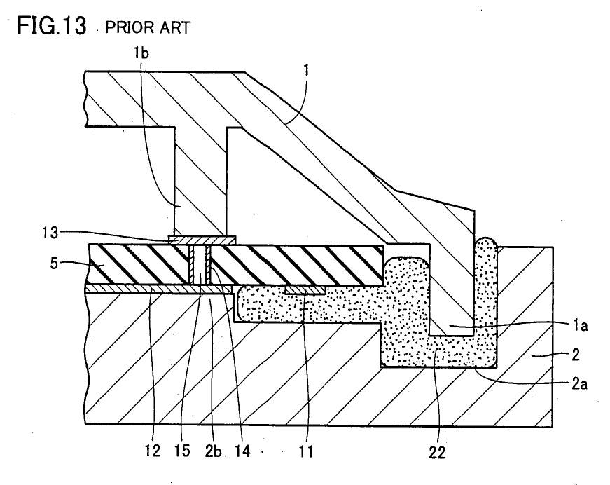

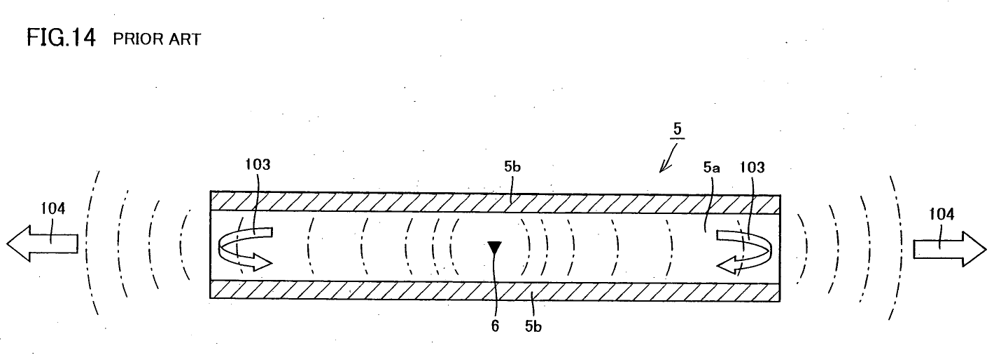

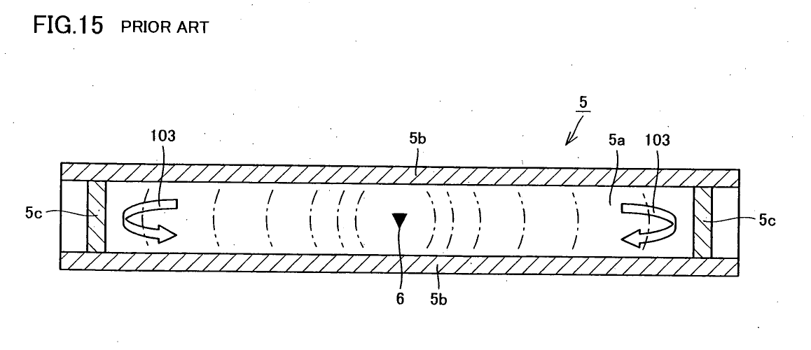

The LNB converter has been described as an example of the communication device in the embodiment. However, the invention can be applied to various communication devices other than the above. For example, the invention can be applied to a transmitter (see FIGS. 10 and 12) in the antenna device. Further, the invention can be applied to various electric devices other than the communication device.

In the figures already described, the same or corresponding portions bear the same reference numbers. In the description already made, the wordings such as “upper” and “lower” do not represent, e.g., “upper” and “lower” in the absolute vertical direction, and represent relative positional relationships.

The invention provides the communication device preventing such a situation that the seal member filling the space between the frames of the casing comes into contact with the dielectric substrate to cause the oscillation of the electric circuit formed on the dielectric substrate.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A communication device comprising:
a first frame made of metal and having an edge;
a second frame made of metal and having an opposite portion opposed to said edge; and
a dielectric substrate arranged in a space surrounded by said first and second frames, wherein
said dielectric substrate includes an electric circuit formed at a surface of said dielectric substrate,
said edge and said opposite portion are fixed together by a seal member,
a cushion member is arranged between said edge and said opposite portion, and
said cushion member is arranged to prevent said seal member from entering said space and coming into contact with said dielectric substrate.

2. The communication device according to claim 1, wherein
said dielectric substrate is fixed by being held between said first and second frames.

3. The communication device according to claim 1, wherein
said cushion member is arranged only on a part of an opposed region between said edge and said opposite portion.

4. The communication device according to claim 1, wherein
said cushion member includes a soft resin foam.

5. The communication device according to claim 1, wherein
said cushion member has a surface coated with an electrically conductive sheet.

6. The communication device according to claim 1, wherein
said cushion member includes a wave absorber made of a sponge material.

7. The communication device according to claim 1, wherein
said communication device has a function of an LNB converter.

8. The communication device according to claim 1, wherein
said communication device has a function of a transmitter.
